(19) United States
(12) Patent Application Publication
(10) Pub. No.: US 2003/0233578 A1
(43) Pub. Date: Dec. 18, 2003

(54) Secure fault tolerant grouping wireless networks and network embedded systems

(75) Inventor: Bruno Dutertre, Mountain View, CA (US)

Correspondence Address: Deborah A. Neville, Esq., 4328 Canoas Drive, Austin, TX, 78730, US

(73) Assignee: SRI INTERNATIONAL

(21) Appl. No.: 10/186,555

(22) Filed: Jun. 28, 2002

Related U.S. Application Data
(60) Provisional application No. 60/384,662, filed on May 31, 2002.

(51) Int. Cl. G06F 11/30

(52) U.S. Cl. 713/201

(57) ABSTRACT

The invention provides an inexpensive intrusion tolerant serverless architecture and protocols for authentication and key management for large-scale self organizing networks of small embedded systems. Localized protocols for establishing trust relationships between neighboring devices are provided as well as methodologies for the building of more global authentication and key distribution from such localized trust. Embodiments include wired and wireless networks.

This application claims the benefit of U.S. provisional application 60/384,662 filed May 31, 2002, incorporated by reference in its entirety.

### GOVERNMENT FUNDING

The invention was made with Government support under contract Number N66001-00-C-8001 awarded by Space and Naval Warfare Systems Center. The Government has certain rights in this invention.

### FIELD OF INVENTION

The invention relates to security in networked systems. More particularly, the invention relates to security in self-organizing networks and to secure grouping in any manner of wired or wireless networks, including MANETs.

### BACKGROUND

Good security is essential to the deployment of networked embedded systems in critical domains. In hostile environments, adversaries can monitor wireless communications, send malicious signals, and compromise individual devices. However, the trust management services that are essential to network security are difficult to implement when devices have limited processing and memory, and communication is at low power and low bandwidth. What is needed is a means of providing lightweight, intrusion tolerant authentication and key management suitable to such networks.

Small processors with limited communications and power are being embedded in almost all of our everyday devices. In some critical applications such as military sensor networks, confidentiality and integrity of communication must be ensured. A network of very small, resource constrained; wireless devices must also tolerate loss, failure, or compromise of some of the devices while maintaining some of degree of security. Because the devices have very limited computation, power, and communication bandwidth, traditional security solutions such as public key cryptography or server based approaches are not applicable. A further difficulty is that access to the devices once they are deployed is often impossible, which prohibits manual configuration or administration after network deployment.

Networks of small-embedded systems have potential applications in critical domains, where taking actions from inaccurate or maliciously corrupted data could be disastrous. Security mechanisms are essential to ensure the authenticity, confidentiality, freshness, and integrity of the critical information collected and processed by such networks. This requires strong entity authentication and key management that are resilient to external attack on the network and to failure or compromise for some of the network nodes.

If all devices have sufficient and processing power, approach is based on public key cryptography or on the Diffie-Hellman key agreement protocol may be applicable. However, the necessary cryptographic primitives are currently too expensive for the most resource constrained devices. Traditionally, less costly alternatives employ trusted servers that share a long-term secret with each client. Such approaches have significant administrative overhead as clients must be registered and keys set up. Servers must have sufficient memory and computation power to ensure good performance and strong connectivity must exist between clients and servers. Furthermore, unless additional costly measures are taken, compromise of a server can be devastating. These disadvantages and constraints make server based solutions inadequate for networks of small-embedded devices. What is needed is inexpensive intrusion tolerant and serverless architectures and protocols for authentication and key management for large-scale self-organizing networks of small-embedded systems. What is also needed is secure grouping in mobile ad hoc networks, whether such networks are wholly or partially wired or wireless.

### SUMMARY OF THE INVENTION

The invention provides a means of insuring intrusion tolerant authentication and key management services for large scale self-organizing networks of small, embedded devices. The invention also provides intrusion tolerant secure grouping or virtual private network with a wired networks or wireless networks, including mobile ad hoc networks. The inventive approach provides authentication and key management services using only inexpensive cryptographic primitives (no public key cryptography), do not require servers, and have very small configuration overhead.

The services are implemented in two levels. First, localized trust relationships are established between neighboring devices. This first step is designed to be very efficient and to enable the quick establishment of long-term secure point-to-point links between devices that are within direct communication range of each other within a short period after the network is deployed. The operative assumption is that devices are initially trustworthy but that the risk of failure or compromise increases with time. Initially, a weak form of authentication is sufficient, which can be supplemented by having all devices initialized with a common secret key.

Variations of this scheme with several initial keys can provide increased robustness. Such variations give probabilistic guarantees but local links remain secure even if some of the devices are not initially trustworthy.

The second step enables the establishment of secure links between distant nodes in the network by leveraging the secure local links. This relies on a chaining approach, or by secret material, such as a cryptographic key, is transmitted to a distant node via a chain of trusted intermediaries. To provide resilience to node compromise, disjoint chains of intermediaries and secret-sharing techniques can be used. The principle is to split a secret into several shares and distribute each share via a distinct chain to ensure that no node along the chains can construct the secret.

### BRIEF DESCRIPTION OF THE DRAWINGS

FIG. 1 illustrates intrusion tolerance principles.

FIG. 2 depicts a generalized localized network.

FIG. 3A depicts a network according to the invention.

FIG. 3B depicts a network according to the invention.

FIG. 4 A-E depicts TBRPF as compatible with the inventive embodiment.

FIG. 5 depicts a network layer conceptualization consistent with the invention.

FIG. 6 depicts a network layer conceptualization consistent with the invention.

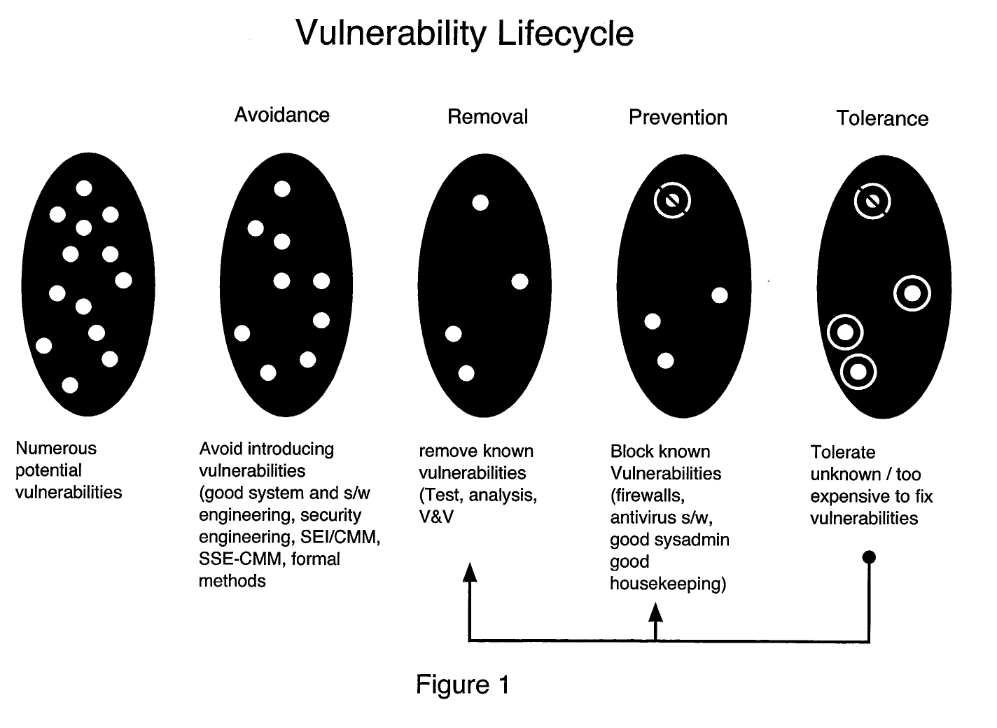

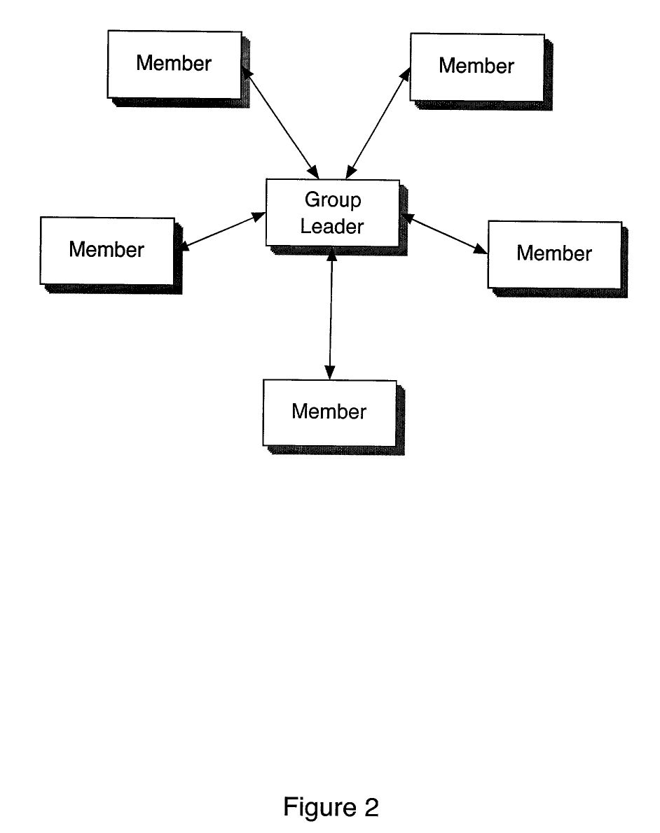

### DETAILED DESCRIPTION OF THE PREFERRED EMBODIMENT

Authentication and key management requires initial trust between some of the parties involved. For example, a public key certificate is accepted as valid if signed by an authority one trusts. If only symmetric key cryptography is used, the parties that trust each other must some how acquire a common shared secret that will enable them to communicate securely. The initial keys that are necessary to bootstrap the authentication services are typically set up by hand. For example, if a central authentication server is used, an initial shared key is distributed by an administrator when the client is registered with the server. This initial key is typically communicated off-line to ensure secrecy.

In the case of large networks of embedded devices, manually setting a large number of keys is not practical. In many scenarios, access to the devices for administration is impossible once the devices are deployed. For example, a large set of micro-sensors can be dropped from a plane over an inaccessible region or deployed in a toxic environment. In such cases device configuration is possible only before deployment, and there are no secure off-line channels. Once deployed, the network should be autonomous and self-organizing. The initial keys should then be set up securely by the devices themselves, without manual intervention.

Although the invention may be practiced in a wired network, the example provided hereinbelow are discussed in terms of wireless devices, and particularly including in a mobile ad hoc environment. This is selected as it is the most difficult condition to satisfy, and is therefore instructive, but as such it should not be construed as any limitation to the application of the inventions taught herein. The typical scenario is for a set of S of N wireless devices to be deployed or dropped in the environment. At this point, the devices must discover their neighbors and self-organize in an ad hoc network. During this initial phase, the main security concerns are external attacks and possibly malicious devices are already present in the environment. The devices from S themselves may be assumed initially trustworthy as it takes time for an adversary to compromise them. As the risk of device compromise increases with time, it is crucial to quickly establish the initial secure links. This calls for an efficient localized algorithm with minimal communication overhead. The inventive approach is to then focus on building initial trusted links between nodes that are within direct communication range of each other. The localized algorithm also increases security while avoiding the distribution of critical information such as key across many network links.

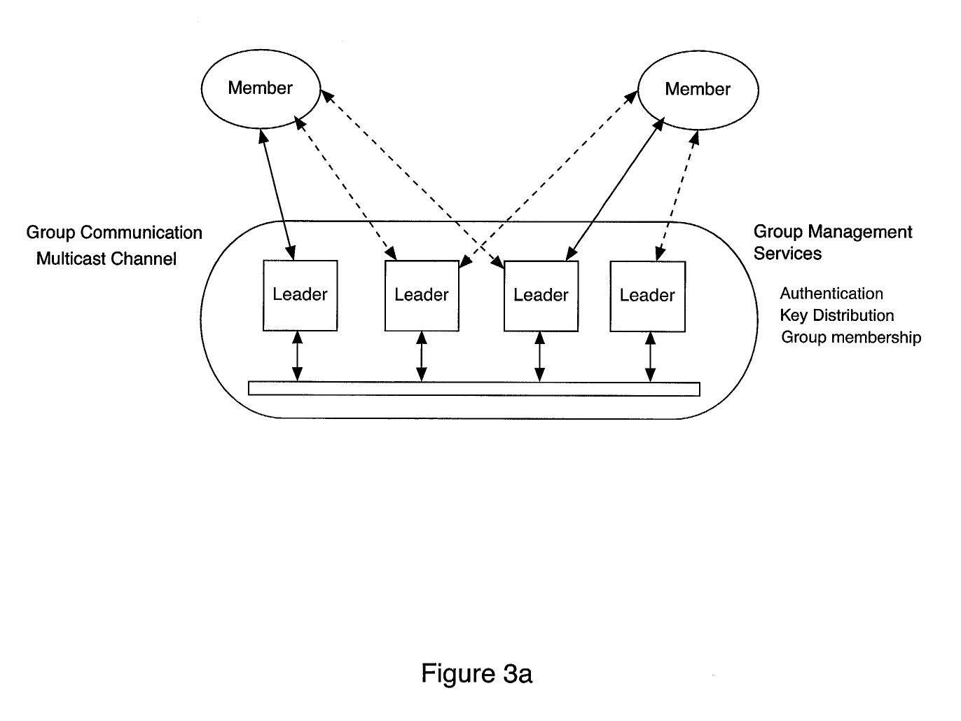

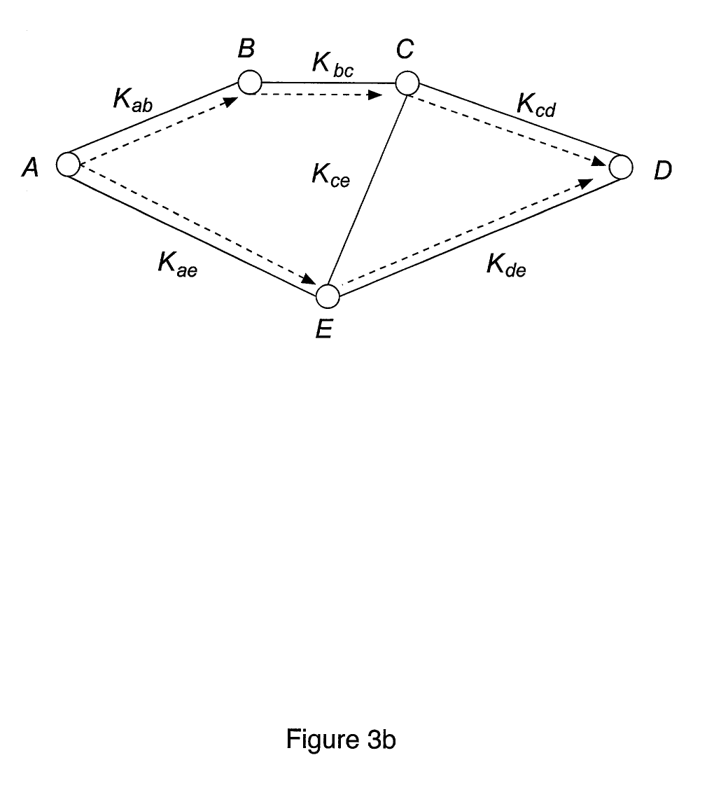

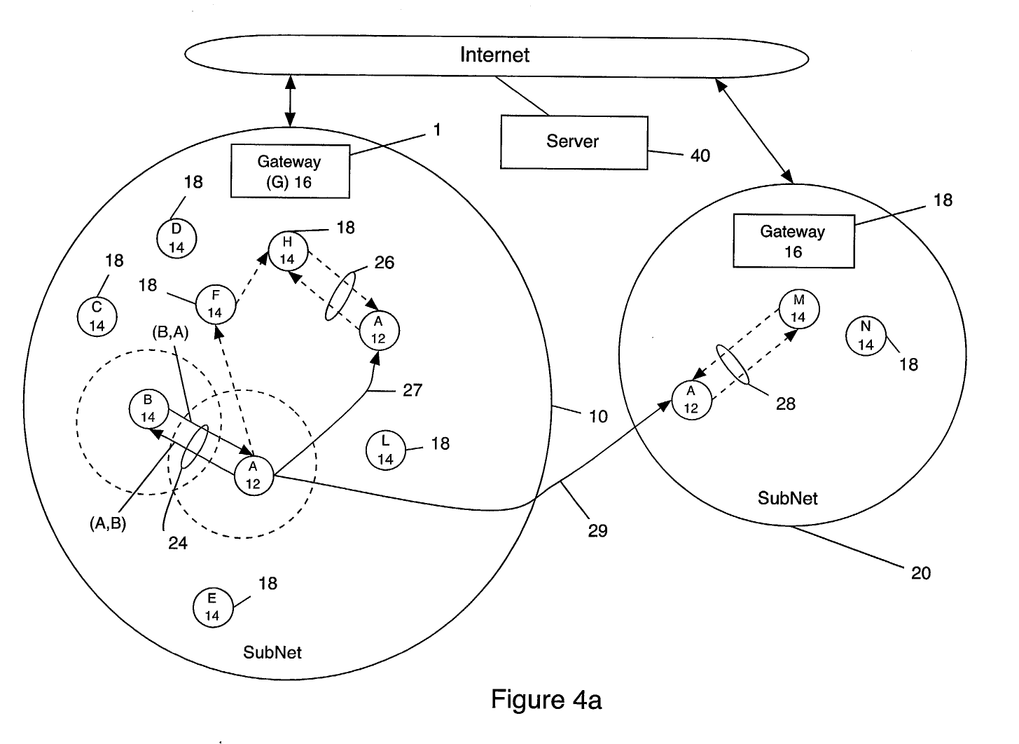

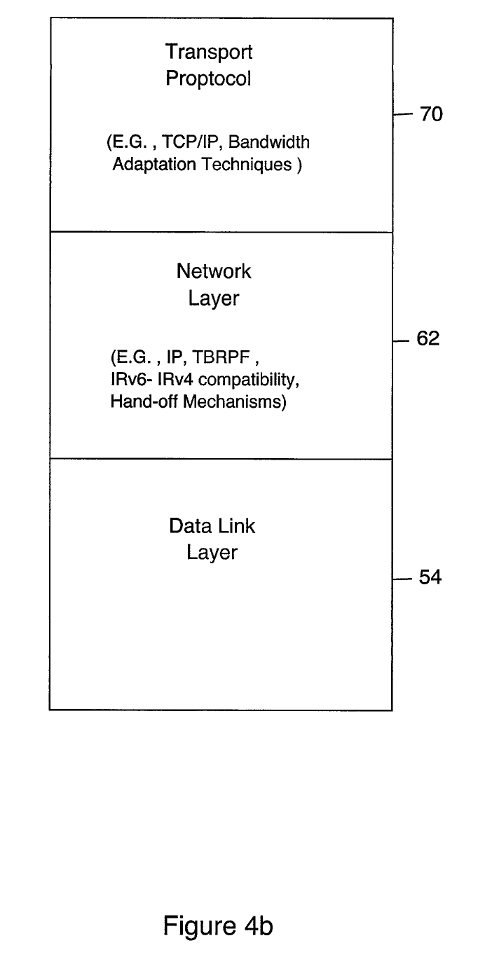

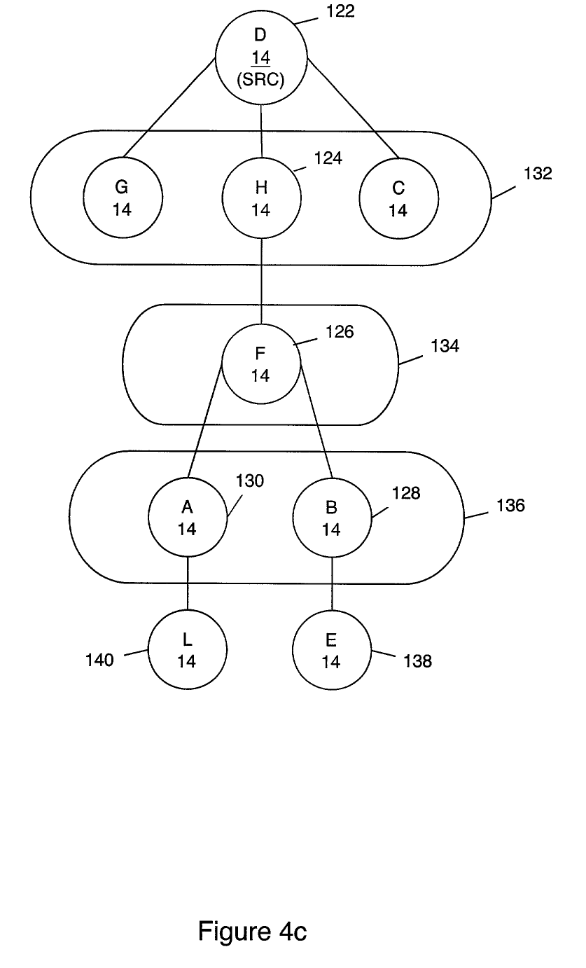

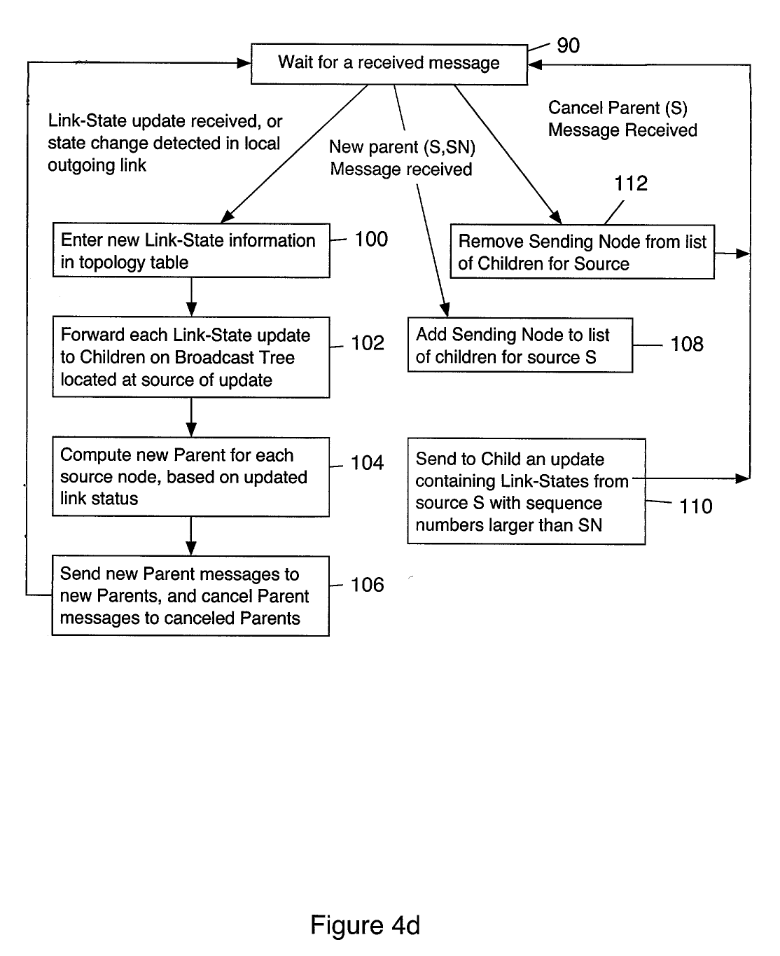

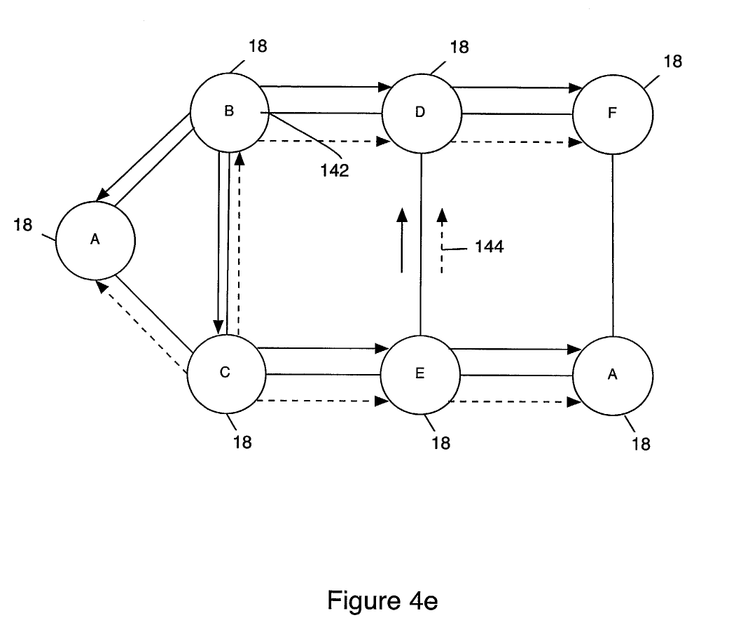

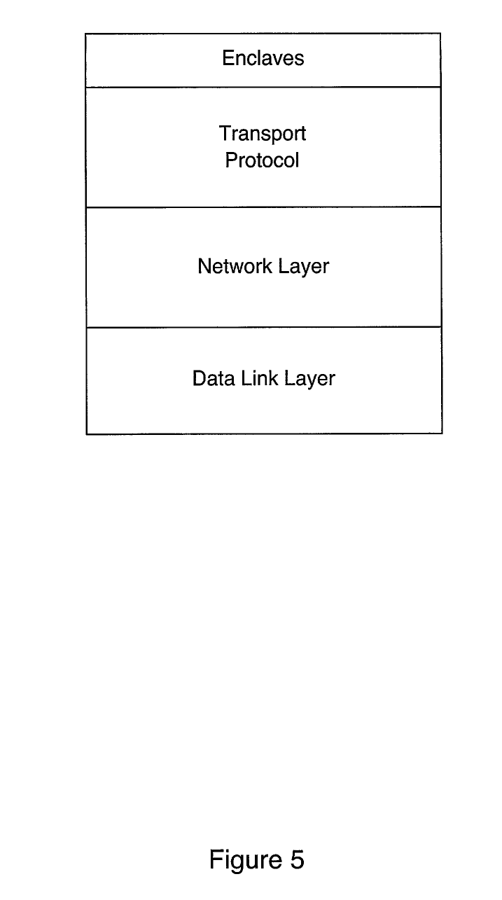

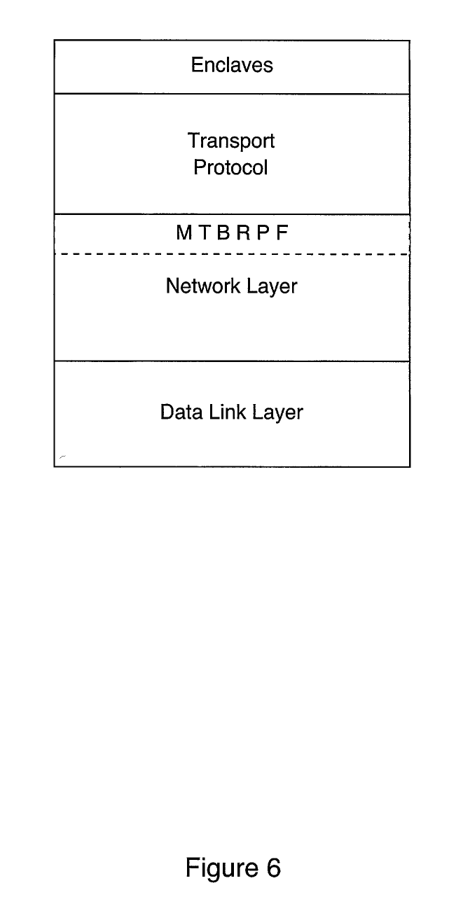

If all devices of S are initially trustworthy, then two neighbors A and B, as depicted in FIG. 3B, can establish a secure link if they can make sure that both of them belong to S. Hence, a fairly weak form of authentication is sufficient, namely, the ability for a device to prove that it belongs to S. This can be implemented cheaply by simply distributing a single common key K to all the members of S. Setting this initial key is not more difficult than storing a common program in the devices, and has very minimal administration overhead. The key K can also be used for A and B to securely exchange a more permanent key K_{ab} to secure local communication between themselves.

By this approach, any member of S within communication range of A and B can also obtain K_{ab} since it knows K. This is not a problem if all the devices of S are initially trustworthy. In case of doubt, more robust versions of the scheme can be investigated. A possible generalization is as follows. Before deployment, a set of m keys K₁, . . . , Kₘ is generated and each device is assigned a subset of n randomly chosen keys out of these (where n<m). A and B can then establish a secure link if they have one Kᵢ in common, but K_{ab} is not accessible to devices that do not possess the same Kᵢ. Thus, the probability that K_{ab} is discovered by neighbors of A and B is reduced. This gives probabilistic guarantees of secrecy in the presence of initially compromised devices in S. The current embodiment retains a focus on estimating the degree of resilience achieved depending on parameters such as m and n.

Variations of this method will occur to those of skill in this area, and are intended to be included in the description of this invention.

### LEVERAGING LOCAL TRUST

Localized protocols enable local secure links to be established between neighbor devices in a short period after deployment. Adjacent nodes that have authenticated each other as members of the same community S share a symmetric secret key.

In light of power and bandwidth constraints, there are clear advantages in employing very localized algorithms in NEST applications. Algorithms that require only limited interaction between distant nodes are more scalable and energy efficient. Therefore, ensuring the security of local links may be what matters most in many applications. Nonetheless, communication between nodes that are not within direct communication range of each other cannot be ruled out. For example, a network of microsensors may also include other devices with increased computation power for analysis, correlation, or distribution of the result outside the network. In such a case, data collected by the sensor may need to be transmitted to these other devices. There is then a need for supporting authentication, confidentiality, or integrity of communication between distant nodes. We propose to build on the existing local trust, constructing secured links between distant nodes via chains of intermediaries, relying on local trusted links between successive nodes in the chains.

For example, as can be seen by referring to FIG. 3B, device A can authenticate and exchange a symmetric key K_{ad} with device D via the chain A→B→C→D. The details of such a mechanism remain to be defined, but it will require a succession of decryption and re-encryption by the intermediate nodes. Once A and D share a common key K_{ad}, they can communicate securely through any path from A to D. The intermediate nodes on such a path need only be trusted to forward messages.

It is clear that such a key exchange is secure only if all the intermediate nodes are trustworthy. If one of them is compromised, the key K_{ad} may be revealed to the adversary. Compromises may also lead to authentication failures. For example, if it is compromised, device C may be able to masquerade as A to D.

To provide resilience to device compromises, a more general approach must be developed. One solution is to assume that some intrusion detection mechanism is present and avoid nodes that are reported as compromised. Since intrusion detection is not perfect, the invention also provides authentication and key-establishment protocols that rely on disjoint chains. In FIG. 3B, A and D can thus authenticate by using two disjoint paths: one via B and C and the other via E. To distribute a key between A and D, secret-sharing algorithms could then be applied, with one share of the key sent over each path. As long as no more than one of B, D, and E is compromised, the key remains secret. More than two disjoint paths must be employed to achieve stronger security guarantees. Other variations can be examined, including asymmetric chaining where key-establishment messages from A to D and from D to A follow different chains.

There exist verifiable secret-sharing algorithms that are inexpensive enough to be used in this context. The invention contemplates protocols for intrusion-tolerant authentication and key distribution via disjoint paths, built on such algorithms.

The security guarantees such a scheme offers depend on the number and location of compromised nodes, the number of disjoint chains, and the number of nodes in each chain. As sending data through several paths may be expensive, determining the right tradeoff between security guarantees and cost is essential. An aspect of this invention includes the relationship between intrusion tolerance properties and cost, for the authentication and key-management protocols.

### INTRUSION DETECTION AND RESPONSE

Availability of a sensor network is security critical. If the nodes used for key agreement and distribution are unavailable, the NEST (Network Embedded Security) devices will not have a secure means to dynamically establish cryptographic keys for authentication and encryption. Instead of attacking the key-management infrastructure, an adversary may also render the NEST devices useless by subjecting them to denial-of-service (DoS) attacks. Because of the resource constraints (particularly power limitation) of NEST, novel DoS attacks need to be considered. These attacks are not a major threat in conventional computer networks and have received little attention in intrusion detection (and in computer security in general).

For TCP/IP networks, DoS attacks are used to crash a server or to exhaust certain resources of a host (e.g., TCP SYN flooding attacks fill up the connection table data structure of a server to prevent it from accepting new TCP connection requests [4]). One usually can recover from these attacks by using a timeout mechanism or restoring the victim to the last known safe state.

Because of the special power constraints and the autonomous nature of NEST, there are denial-of-service attacks that are different from those for TCP/IP networks. A major threat for NEST devices is that an adversary may be able to carry out DoS attacks to use up their power reserve. Specifically, the adversary may perform some actions to keep the energy of a device is used up, this device will be rendered useless and there may not exist a means to replenish the power of this device in time.

### ATTACK SCENARIOS

Consider a mission involving a set of devices in a region to collect data and forward the data to a remote base station. The mission requires that every area in the region is covered by three or more sensors. To achieve this mission, these devices invoke a key-management protocol to obtain session keys so that a sensor can securely exchange messages with its peers. Based on the message exchange, a sensor can obtain the operational status of its peer devices and coordinate with them to ensure that every area is monitored.

In the first attack scenario, an adversary active in the region sends a large number of randomly generated messages for a certain period of time. When the devices in the region receive these messages, they will consume power processing and eventually discarding them. These devices will eventually run out of batteries and fail to complete the mission. The adversary can then move to another region and repeat the attack to disable the devices there.

In the second scenario, an adversary compromises a device, say B, that is part of the key-management infrastructure of the sensor network. Using the intrusion tolerance design discussed previously, it should be impossible for the compromised device to cause other devices to use an insecure key for communication. However, the adversary can send bogus but properly authenticated messages to other devices during the execution of a key-agreement protocol to consume their resources. This attack is more subtle because devices may not be able to distinguish whether B fails or another device attempts to make B appear compromised. Denial-of-service attacks similar to the above have been discussed by Stajano and Anderson who explains why approaches based on message authentication and resource allocation cannot satisfactorily handle these attacks. Briefly, there are situations in which a NEST device cannot refuse communicating with an unknown party (e.g., at the beginning stage of a message exchange session). Moreover, a resource allocation strategy may fail when the attack is from an authorized insider (e.g., when another NEST device is compromised). Stajano and Anderson also suggested two other approaches: (1) pay per use and (2) requiring the client to solve a computational expensive problem, or answering a question that is difficult for a machine but easy for a human to solve. Because of the resource constraints and the autonomous nature, these approaches do not appear to be applicable to the NEST domain. The invention provides a novel situation to denial of service attacks.

Approach

To defend against DoS attacks, the invention provides an intrusion detection and response approach to protect sensor networks. The inventive approach involves developing fault models to characterize different behaviors of an adversary. These models enable one to better capture the key properties of the problems and to develop solutions to address them. Based on these models, procedures to detect attacks are developed. Moreover, the inventive approach enables identification of the misbehaving component(s). A response action will be performed to tolerate the attacks or to reconfigure the sensor network to prevent the adversary from affecting the devices in the network.

To illustrate the invention, consider the attack scenarios presented hereinabove. For the first scenario, because the malformed messages may be sent by anyone (including an adversary that does not have access to any “insider” device), it may be impossible to trace the source of the attack, which limits the response options one may use. This may be modeled as a transient fault. In this model, a device exhibits the anomalous behavior only for a certain amount of time and then it will become normal. To tolerate attacks of this class, an effective response for a device is to go into a hibernation mode to conserve energy. After a certain period of time, the device will reactivate itself. If the attack is still ongoing upon wake-up, the device will go back to hibernation. Otherwise, it will resume its operation.

For more sophisticated attacks such as the one shown in the second scenario, a more complicated and costly solution is in order. A technique used in intrusion detection, called threshold analysis, may be applied to detect these attacks: If a device A has failed to use another device B to establish a key with more than x different peers within a period of y seconds, A may infer that B is suspicious and decide not to use it. A more elaborate response may involve notifying other devices located in the same region. Based on the alerts received, a device may decide to stop using B, and possibly find a replacement device for future key-management needs.

The invention described herein provides for evaluation and comparison different solutions based on coverage, false-alarm rate, cost, and responsiveness. Coverage and false-alarm rate are standard measures of the effectiveness and accuracy of intrusion detection systems; there is usually a tradeoff between the two. Because of the resource constraints of the NEST networks, a good solution should also have low resource requirements with respect to processing, memory, bandwidth, and—most important—power. Finally, the system according to the invention should have the ability to recover and continue to function after intrusions are detected.

While the invention has been shown and described with reference to specific preferred embodiments, it should be understood by those skilled in the art that various changes in form and detail may be made without departing from the spirit and scope of the invention as included in the following claims.

What is claimed is:

1. In a network of embedded systems, a system of security, comprising:
means for serverless architecture; and
means for authentication and key management,
said severless architecture and authentication and key management means operable so that said network is intrusion tolerant.

2. A system as in claim 1 further including means for intrusion detection.

3. A system as in claim 1 further including means for identifying compromised nodes.

4. A system as in claim 1 further including means for resisting denial of service attack.

5. A system, where such system is a secure network of embedded systems, said system comprising:
embedded system devices neighboring each other,
means for autonomously establishing secure links after devices are deployed.

6. A system as in claim 5 further comprising means for extending trust to non-neighboring nodes/distant nodes.

7. A system as in claim 6, where such means for extending trust includes chaining.

8. A system as in claim 6, where such means for extending trust includes the use of multiple paths.

9. A system as in claim 6 where such means for extending trust includes secret sharing for intrusion tolerance.

10. A system as in claim 6 where means for extending trust includes chaining, use of multiple paths, and secret sharing for intrusion tolerance.

11. A method of deploying networked embedded systems, said systems having a high security level, where such method comprises:
establishing secure links between neighboring network devices within a short time after deployment;
extending trust to distant nodes.

12. A method as in claim 11 where extending trust includes chaining, using multiple path, and secret sharing for intrusion intolerance.

13. A method as in claim 11 further including means for intrusion detection,

14. A method as in claim 13 further including means for identifying compromised nodes.

15. A method as in claim 14 further including means for resisting denial of service attack.

16. A system of secure communication between subsets of nodes of a network, said system comprising:
a plurality of interconnected nodes communicatively coupled with each other as method node of a virtual private network (VPN);
a plurality of said interconnected nodes acting as leaders, where each leader shares the responsibility for group management activities.

17. A system as in claim 16 wherein the system tolerates intrusion of up to a predetermined number of leaders.
